(19) United States
(12) Patent Application Publication
(10) Pub. No.: US 2014/0083726 A1
(43) Pub. Date: Mar. 27, 2014

(54) Drill Driven Weed Removal Tool

(71) Applicant: Vern L. Ader, Marshfield, WI (US)

(72) Inventor: Vern L. Ader, Marshfield, WI (US)

(21) Appl. No.: 13/626,940

(22) Filed: Sep. 26, 2012

(51) Int. Cl. A01B 1/16

(52) U.S. Cl. CPC A01B 1/16
USPC 172/41

(57) ABSTRACT

A multi-purpose drill driven tool for removing weeds, roots and other debris from the earth with minimum disturbance to the surrounding soil. The tool includes a vertical shaft, of sufficient length, that attaches to a drill to permit operation in the vertical position. The lead point of the drive shaft is tapered and flat, which permits fastening the two opposing cutters at a double angle on the shaft and efficient penetration into the soil. The spinning action of the cutters removes the weeds, roots and all, while simultaneously spinning the removed weeds and roots off the cutter head and blades.

### CROSS-REFERENCE TO RELATED APPLICATIONS

This application claims the benefit of provisional patent application Ser. No. 61/626,693 filed 2011 Sep. 30 by present inventor.

### BACKGROUND

1. Field of the Invention

This invention relates to the drill driven multi-purpose weeding tool and more specifically to an improved tool for removing weeds and other undesired debris by engaging the weed and entire root system with a spinning motion that also spins the weeds and roots off the cutter head with minimum disturbance to the surrounding soil and other plants.

2. Prior Art

The prior art has numerous hand and drill driven weed removal tools as well as chemicals that have been used for deterring, removing or destroying weeds, plant growths and other undesirable debris that are in lawns, gardens and other desirable locations. Many of these undesirable weeds, plants and debris have complex, elaborate and deep root systems that are difficult to completely remove and prevent their regeneration. Hard, gravely and rocky soil conditions further complicate the removal of these undesirable plants. Also conventional weeding and cultivation brings all the dormant weed seeds to the surface. The freshly tiled soil prepares the perfect seed bed for the weed seeds to germinate in.

The prior art shows a variety of power weeding tools with prongs , spikes, wires, rods, drill/auger, wings and twister styles for weed removal. All of these tools work, but each one has limitations and drawbacks. These drawbacks include working only in ideal soil conditions, partial weed and root removal, taking the weed off the weed removal tool and disturbing the area around the existing weed upon removal.

There is a movement in many areas to ban toxic chemicals for varying uses including lawns due to their harmful effects on children, pets, organisms, birds, fish and water supplies. What is needed is a weed removal tool that overcomes all of these drawbacks, removes the entire weed and root, works in all types of soils, does not disturb the surrounding area of the weed and can be operated in the standing position to save on the operators knees and back.

### SUMMARY OF THE INVENTION

The object of the invention is to provide a multi-purpose drill driven weed removal tool with a drive shaft that has three flats on the driving end to prevent slippage in the cordless or electric drill. The bottom end of the drive shaft has a tapered flat end for penetration into the soil and fastening of the two opposing cutters. The shaft is of sufficient vertical length to facilitate the user to operate the weed removal tool in the standing position.

The lower cutter blade near the ground is shorter than the opposing cutter blade above it which facilitates entry into the weed and ground to initiate the weed removal action by the spinning cutter head. Pushing the tool further into the ground and weed activates the second cutter blade to completely remove the weed and its roots and spin them off the cutter head and its two blades. The tool is pushed into the ground and weed root, to the depth of the root, without drilling a hole in the ground and disturbing the surrounding soil.

The two opposing cutter blades are offset approximately 180 degrees. The blades are uniquely designed with a leading tapered sharpened front and a trailing dull back. As shown on the drawing the blades have a double angle. The front of the cutter blades are angled down slightly with the leading cutting edge lower than the trailing back edge. The entire blades are also angled down from the horizontal or less than 90 degrees from the blade to the shaft flat surface it is fastened to toward the ground surface. Although the cutter blades work without the double angle in the straight horizontal, the double angle provides the most efficient method. The leading front edge of the double angle cutter blades grabs the weed and roots first with a progressive action toward the drive shaft center. This double angle with the leading cutting edge also creates a downward pull into the weeds, roots and soil which in turn help extract the weeds and roots. A straight horizontal cutting blade without the double angle applies all the cutting action at once and tends to act like a drill. The unique double angle cutter blades solve the hole drilling problem while simultaneously pulling the cutters into any type of ground surface and assisting in the weed and roots removal.

Another unique feature of the tapered flats on the lower shaft end is that the flats guide the weed removal tool into the weeds, roots and ground, start the removal action for the cutting blades, serve as a pivot point at the shaft end and act as an auger to penetrate into hard soil, where as a round tapered point only serves as a pivot point for the driving shaft end.

The following is a tabulation of some prior art that presently appears relevant:

### U.S. Patents

| Pat. No. | Issue Date | Patenee |
|---|---|---|
| 0100652 A1 | 2011-05-9 | Motosko |
| 7,314,095 | 2008 | Cobb |
| D537686 | 2007-03-6 | Yates |
| D536226 | 2007-02-6 | Yates |
| 6,951,255 | 2005=10-4 | Shepherd |
| 6,722,444 | 2004-04-20 | McKill |
| 6,736,217 | 2004-05-18 | Brown |
| 6,595,289 | 2003-07-22 | Crady |
| 6,615,928 | 2003-09-9 | Dueitt |
| 6,119,787 | 2000-09-19 | Garcia |
| 6,050,344 | 2000-04-08 | Larson-Morrell |
| 5,909,778 | 1999-06-08 | Acosta |
| 5,441,118 | 1995-08-15 | Cruz |
| 5,261,496 | 1993-11-16 | Smotherman |
| 4,819,736 | 1989-04-11 | Hedgepeth |
| 4,723,802 | 1988-02-09 | Fambrough |
| D278065 | 1985-03-19 | Sydlowski |
| 3,997,279 | 1976-12-14 | Porter |
| 3,554,293 | 1971-01-01 | Aman |

### Objects and Advantages

Accordingly several object and advantages of the present invention are:
(a) To provide a tool that removes the entire weed and root with one spinning motion;
(b) To provide a tool that spins the removed weed and root system off the cutter head simultaneously with the spinning action of the cutter head;
(c) To provide a tool that works in all types of soil conditions;
(d) To provide a tool that does minimum disruption to the soil and plants surrounding the removed weed;
(e) To provide a tool that removes the weed and root without drilling a hole in the ground;
(f) To provide a tool that can be used in the standing position to save the knees and back of the user;
(g) To provide a tool that works with any cordless or electric drill;
(h) To provide a tool that is Eco-Friendly-No more harmful chemicals;
(i) To provide a tool that is low cost and durable;
(j) To provide a tool that is fast, efficient and easy to use ;
   Further objects and advantages of my invention will become apparent from a consideration of the drawing and ensuing description.

### DRAWINGS: REFERENCE NUMERALS

10 Weed Removal Tool

11 Shaft

12 Lower End Shaft

13 Upper End Shaft

14 Cutter Blade—Long

15 Cutter Blade—Short

16 Welds

### DRAWING FIGURES

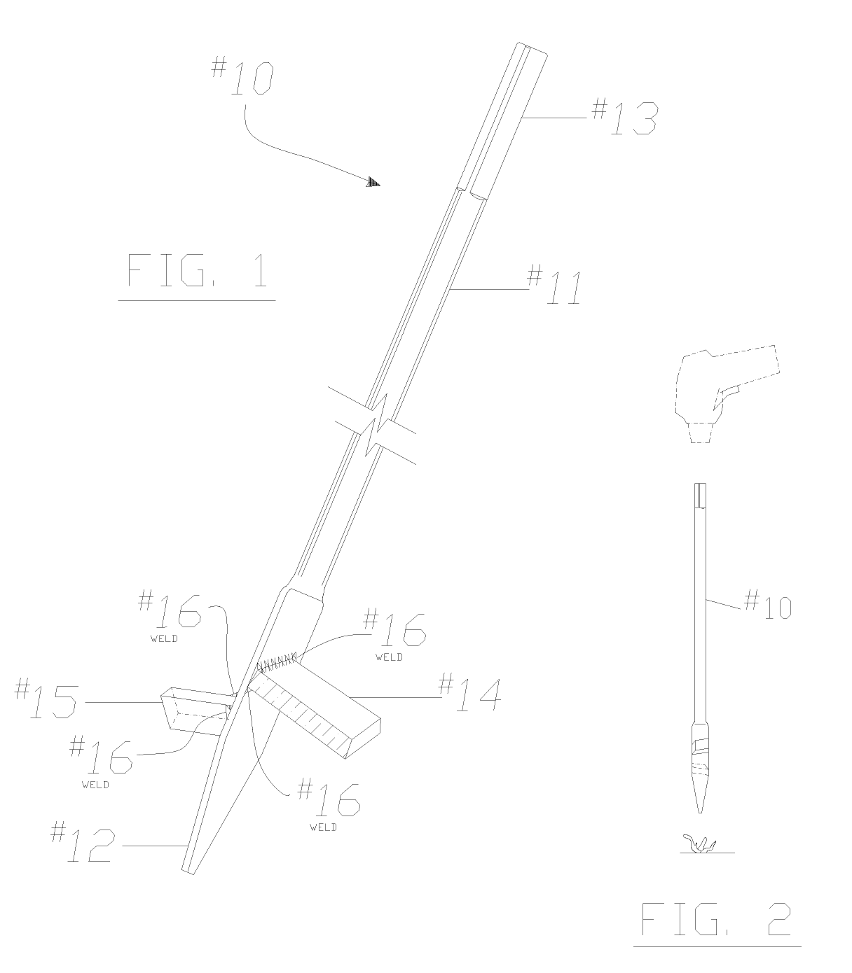

FIG. 1 is a perspective view of a typical embodiment of the weed removal tool designed in accordance with the present invention.

FIG. 2 is a side view featuring the drill driven method of driving the weed spinner.

### DESCRIPTION OF THE PREFERRED EMBODIMENT

A typical embodiment of the present invention is illustrated in FIG. 1. The weed removal tool 10 includes an elongated central shaft 11 with a lower end shaft 12 and a upper end shaft 13. The lower end shaft's tapered flats 12 includes a short cutter blade 15 and a long cutter blade 14 which are attached to the lower end shaft flats at a double angle. The upper end shaft includes three flats 13 that is attached to a drill to spin the weed removal tool. As seen on FIG. 1 the short cutter blade 15 is located approximately 180 degrees opposite and below the long cutter blade 14 on the lower shaft end 12. The double angle of the cutter blades 14 and 15 slants the blades down and forward from the horizontal by their attachment by welds 16 to the lower end shaft 12. Also as seen on FIG. 1 the cutter blades 14 and 15 have a sharpened lead end with clearance to maintain the cutting edge. FIG. 2 shows the weed removal tool 10 in the vertical position being driven by a cordless or electric drill in the desired position to remove weeds or other undesired debris. Although the description above contains many specifications, these should not be construed as limiting the scope of the invention, but as merely providing illustrations of some of the presently preferred embodiments of this invention. For example the cutting blades can project straight out horizontally from the vertical drive shaft or project downward at an angle as shown in the preferred embodiment. Thus the scope of the invention should be determined by the appended claims and their legal equivalents, rather than the example given.

1. A multi-purpose drill driven weed removal tool comprising:
(a) a rotatable shaft having an upper end and a lower end, the upper end having three flats, the lower end having a flat taper end; and
(b) a pair of opposing cutter blades attached at a double angle to the flats of the shaft, the blades on the first angle are slanted downward from the horizontal at an acute angle to the flat on the shaft which is the vertex of the angle, the cutter blades on the second angle are also slanted downward from the horizontal with the bottom flat plane of the cutter blades forming an acute angle with the horizontal, making the top back plane edge of the cutter blades the vertex of the angle.

2. The multi-purpose weed removal tool of claim 1, wherein said double angled cutter blades create a unique downward pull and cutting action into the weed, roots and soil caused by the double angled lead cutting edge with its progressive spinning cutting action toward the shaft center.

3. The multi-purpose weed removal tool of claim 1, wherein said lower shaft tapered flats are forged or stamped from the shaft into a tapered end with the flats being equal distance from the shaft center.

4. The multi-purpose weed removal tool of claim 3, wherein said lower shaft tapered flats guide the weed removal tool into the weeds, roots and ground, start the removal action for the cutting blades, serve as a pivot point at the shaft end and act as an auger to penetrate hard soil conditions.

5. The multi-purpose weed removal tool of claim 1, wherein said blades oppose each other 180 degrees, the lower blade being shorter than the opposing higher blade.

6. The multi-purpose weed removal tool of claim 1, wherein said opposing blades are spaced apart with the shorter blade on the bottom and the longer blade on top.

7. The multi-purpose weed removal tool of claim 1, wherein said blades have a sharpened cutting edge with clearance to maintain the cutting edge.

8. The multi-purpose weed removal tool of claim 1, wherein said shaft tapered flats come to a taper end for penetrating all types of soil conditions.

9. The multi-purpose weed removal tool of claim 1, wherein said cutter blades are made from quality material to maintain their cutting edge.

10. The multi-purpose weed removal tool of claim 1, wherein said top end of shaft has three machined flats to prevent slippage in the driving drill chuck.
